(19) United States
(12) Patent Application Publication
(10) Pub. No.: US 2010/0168407 A1
(43) Pub. Date: Jul. 1, 2010

(54) Quaternized Carboxymethyl Chitosan Derivatives and Preparation Method Thereof

(75) Inventors: Pengcheng Li, Shandong (CN); Zhanyong Guo, Shandong (CN); Song Liu, Shandong (CN); Ronge Xing, Shandong (CN); Huahua Yu, Shandong (CN); Pibo Wang, Shandong (CN); Xiaolin Chen, Shandong (CN); Cuiping Li, Shandong (CN)

Correspondence Address: SMITH, GAMBRELL & RUSSELL, 1130 CONNECTICUT AVENUE, N.W., SUITE 1130, WASHINGTON, DC, 20036, US

(73) Assignee: Institute of OCeanology Chinese Academy of Sciences, Shandong (CN)

(21) Appl. No.: 12/063,227

(22) PCT Filed: Jul. 24, 2006
(86) PCT No.: PCT/CN06/01828

§ 371 Date: Feb. 7, 2008

(30) Foreign Application Priority Data
Sep. 2, 2005 (CN) 200510044546.8

(51) Int. Cl. C08B 37/08

(52) U.S. Cl. 536/20

(57) ABSTRACT

The invention relates to a novel kind of chitosan derivative, specifically to quaternized carboxymethyl chitosand derivatives and preparation method. Chitosan with different molecular weight reacts with chloroactic acid give rise to carboxymethyl chitosan. After reaction of Schiff based, deoxidized and quaternized, quaternized carboxymethyl chitosan is obtained. This kind of chitosan derivative have better water-solubility and better antifungal activity, which can used in the fields of medicine and agriculture.

### FIELD OF THE INVENTION

The invention belongs to the field of Marine-Chemical technique, relate to quaternized carboxymethyl chitosan and its preparation method. The concrete process is described as follows: Schiff bases of carboxymethyl chitosan are synthesized and these compounds are reduced. Then, reduced products react with iodomethane under alkali condition, giving rise to quaternized carboxymethyl chitosan derivatives, which have antifungal activity.

### BACKGROUND OF THE INVENTION

The development of fungicide is high-tech, high investment project with high risk. At present, the preparation of a novel successful fungicide need 5-8 years with the expenses of 100-200 million dollar, selected from 100 thousands compounds. And the cost will be increased with the increasingly environment problem. There only several international companies such as Aventis, Bayer, and Monsanto have the capacity to investigate novel fungicide. How to investigate the own new fungicide of China is very important along with the consummate of intellectual property right and China join in WTO.

In view of the fact of international fungicide market and the current of the study of fungicide as well as the fact of Chinese technology and economy, it is the effective way to cooperate with the international company or take “me-too chemistry” for new fungicide development. According to the theory of “connection of substructure” or “bioisosterism” as well as the present actuality of fungicide, it is feasible to synthesize second lead compound with better antifungal activity and biological degradation. And this approach has more opportunity to succeed because of the clear goal and less cost.

Chitosan is one of the biodegradable, non-toxic amido polysaccharide, with unique property of physiology and pharmacology. Chitosan has been used in fields of medicine, edible, agriculture, cosmetic, and the protection of environment. Chitosan has antifungal activity with the unique character of non-toxic and non-pollution, and it can be modified as the second lead compound. There are active amido and hydroxy groups in the molecule of chitosan, which can be grafted. The activity of chitosan is affected by the amido groups, and the antifungal activity increases with the increase of the density of cation (Kim, C. H.; Choi, J. W. et al. Synthesis of chitosan derivatives with quaternary ammonium salt and their antibacterial activity, Polymer Bulletin, 1997, 38 (4), 387-393). Quaternized chitosan has obvious cation in the Nitrogen atom, which can increase the antifungal activity. However, the research resent years has been done by limiting in the compound only.

Carboxymethyl chitosan has better antifungal activity and better water-solubility compared with chitosan, but there's few further synthesis for carboxymethyl chitosan. Both amido and hydroxyl groups in the molecule of carboxymethyl are substituted by carboxymethyl, and the substituted degree of amido groups is 0.1-0.2 only. There're 80% active amido can take part in other reactions for carboxymethyl chitosan that is obtained from highly deacetylated chitosan (degree of deacetylation is 97%). So, the further modification of carboxymethyl chitosan has prodigious foreground.

Think about the antifungal activity of quaternized chitosan and carboxymethyl chitosan, choose the active amido groups as the modified object can give rise to quaternized carboxymethyl chitosan, which has better bioactivity. However, this kind of chitosan derivative has not reported yet.

### SUMMARY OF THE INVENTION

It is an object of the present invention to provide a synthesis method of quaternized carboxymethyl chitosan from the intermediate of Schiff bases of chitosan. And this compound can combine the antifungal activity of quaternized chitosan and carboxymethyl chitosan, increasing the activity of chitosan. And it has wider industrialization foreground.

The characteristic structure of quaternized carboxymethyl chitosan is shown in scheme (1)

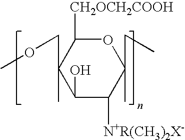

Wherein R is aliphatic aromatic groups; X is I, Br or Cl; n=3-2000 (degree of polymerization)

The preparation method of the present invention is described as follows:

a) The active amido groups of carboxymethyl chitosan react with aldehydes and Schiff bases of carboxymethyl chitosan are obtained;

b) The Schiff bases of carboxymethyl chitosan of step a) are deoxidized with NaBH₄ and N-substituted carboxymethyl chitosan are obtained;

c) The N-substitute chitosan of step b) react with iodomethane under alkali condition and quaternized carboxymethyl chitosan iodide are obtained;

d) The Quaternized carboxymethyl chitosan chloridize of step c) and quaternized carboxymethyl chitosan bromize are obtained after quaternized carboxymethyl chitosan iodide is anion-exchanged. The degree of quaternization is 20.3-41.5%.

Preferably, in step a) the used ratio of the carboxymethyl chitosan and aromatic aldehyde is 1:3-1:5, and the reaction time is 1-3 h.

Preferably, in step b) the Schiff bases of carboxymethyl chitosan are deoxidized with NaBH₄, and the ratio of NaBH₄ and used aldehydes is 1:1.5-1:3. The reaction time is 2-4 h.

Preferably, in step a) the molecular weight of chitosan is 0.16×10⁴-80×10⁴ with the degree of deacetylation 80-100%;

Preferably, in step c) the N-substituted carboxymethyl chitosan is dispersed into N-methyl-2-pyrrolidone for 12 h at room temperature, and the pH of this mixture is adjusted to 9 by 1 mol/L NaOH. Then iodomethane is added. The ratio of N-substituted carboxymethyl chitosan and iodomethane is 1:5. The concentration of I⁻ is adjusted to 0.2 mol/L by sodium iodide, and the reaction time is 12 h.

The degree of deacylation of chitosan used in this invention is higher than 80% (IR spectra data are shown in FIG. 2). Based on the method of Chen Lingyun, Carboxymethyl chitosan with different molecular weight is obtained from the reaction between chitosan and chloroactic acid in the medium of isopropanol (Chen, L. Y.; Du, Y. M.; Liu, Y. Structure-antimicrobial ability relationship of Carboxymethyl Chitosan, J Wuhan Univ. (Nat. Sci. Ed.), 2000, 46(2), 191-194). Obtained carboxymethyl chitosan is dissolved into water and reacted with various aldehydes to obtain Schiff bases of carboxymethyl chitosan. Schiff bases of carboxymethyl chitosan are deoxidized by NaBH₄, and the deoxidized products react with iodomethane under alkali condition to obtain quaternized carboxymethyl chitosan iodide. After anion-exchanged, quaternized carboxymethyl chitosan chloridize and quaternized carboxymethyl chitosan bromize are obtained. As shown in Scheme 1, the degree of quaternization is 20.3-41.5%.

Best mode of the present invention is described as follows:

Carboxymethyl chitosan is dissolved in water at room temperature, and various aldehydes (3-5 fold excess to added carboxymethyl chitosan) are added, respectively, with stirring. After 2 h, 10% NaBH₄ (1.5-3 fold excess to added aldehydes) is added and the reaction is carried out for 2 h. The solution is precipitated in acetone and the precipitants are filtrated. The unreacted aldehydes and other inorganic products are extracted in a Soxhlet apparatus with EtOH for 24 h. And then the N-substituted carboxymethyl chitosan derivatives are obtained after lyophilized. N-substituted carboxymethyl chitosan is dispersed into N-methyl-2-pyrrolidone (NMP) and stay over night. To this mixture, NaOH solution, and CH₃I are added, and each reaction is carried out with stirring at 50° C. for 12 h. After the N-substituted carboxymethyl chitosan derivatives are gradually dissolved, the solution is precipitated by excess acetone and the quaternized carboxymethyl chitosan iodide is obtained by lyophilization. Quaternized carboxymethyl chitosan chloridize and quaternized carboxymethyl chitosan bromize are obtained after quaternized carboxymethyl chitosan iodide is anion-exchanged. The molecular weight of chitosan used in this invention is 0.16×10⁴-80×10⁴ with the degree of deacetylation 80-100%.

The character of this invention is that:
(1) Carboxymethyl chitosan is combined with grafted quaternized ammonium groups, which give rise to synergy of bioactivity, and the bioactivity and antifungal activity are increased.
(2) Choose carboxymethyl chitosan as the grafted object, avoiding the shortcoming of non-water-solubility of chitosan, enlarging the application of chitosan, especially in medicine and agriculture.

### BRIEF DESCRIPTION OF THE DRAWINGS

FIG. 1 is the structure of quaternized carboxymethyl chitosan, and R is aliphatic or aromatic groups; X is I, Br or Cl; n=3-2000.

FIG. 2 is a FTIR spectrum of chitosan. About 3447 cm⁻¹ is the flex vibration peak of O—H and N—H; 2920 cm⁻¹ and 2875 cm⁻¹ are the flex vibration peak of C—H; 1600 cm⁻¹ is the inflect vibration peak of —NH; 1081 cm⁻¹ and 1154 cm⁻¹ are the flex vibration peak of C—O; 897 cm⁻¹ is the loop flex vibration peak of chitosan.

FIG. 3 is a FTIR spectrum of carboxymethyl chitosan, which is in accordance with the result of literature (Dong, Y. M.; Wang, M.; Wu, Y. S.; Ruan, Y. H. FTIR Spectroscopic Determinations of Chitosan Derivatives J. Cellulose Sci. Technol. 2001, 9(2), 42-56). The characteristic peak of —COOH should be appeared at 1731 cm⁻¹, but it disappears in the form of —COONa.

FIG. 4 is a FTIR spectrum of N,N-dimethyl-N-ethylic carboxymethyl chitosan. As the progress of the reaction, the acidity of the solution is increased and —COONa changed to —COOH, then characteristic peak of carboxyl appears at 1742 cm⁻¹. 1653 cm⁻¹ is the characteristic peak of quaternization salt. 1401 cm⁻¹ is the peak of the methyl groups, which grafted to N atom. Above-mentioned results indicate that the target derivatives are obtained.

FIG. 5 is a FTIR spectrum of N, N-dimethyl-N-butyl carboxymethyl chitosan, and 1747 cm⁻¹ is the characteristic peak of carboxyl groups; 1634 cm⁻¹ is the characteristic peak of quaternization salt. 1420 cm⁻¹ is the peak of the methyl groups, which grafted to N atom. Above-mentioned results indicate that the target derivatives are obtained.

FIG. 6 is a FTIR spectrum of N, N-dimethyl-N-phenyl carboxymethyl chitosan, and 1743 cm⁻¹ is the characteristic peak of —COOH; 1647 cm⁻¹ is the characteristic peak of quaternization salt. 1428 cm⁻¹ is the peak of the methyl groups, which grafted to N atom. Otherwise, 758 cm⁻¹ is the characteristic peak of phenyl groups. Above-mentioned results indicate that the target derivatives are obtained.

FIG. 7 is a FTIR spectrum of N,N-dimethyl-N-(2-hydroxyphenyl) carboxymethyl chitosan, and 1737 cm⁻¹ is the characteristic absorb of —COOH; 1611 cm⁻¹ is the characteristic absorb of quaternization salt. 1383 cm⁻¹ is the peak of the methyl groups, which grafted to N atom. Otherwise, 1503 cm⁻¹, 1462 cm⁻¹, and 759 cm⁻¹ are the characteristic peak of phenyl groups. Above-mentioned results indicate that the target derivatives are obtained.

In treating progress, all the samples absorb moisture easily because of the strong hygroscopic property. But, all the characteristic peak of quaternized carboxymethyl chitosan is clear, which prove the experiment is successful.

### DESCRIPTION OF THE INVENTION IN DETAIL

The present invention will now be described with reference to attached drawings and the following examples. However, the following examples are not particularly limited protective range of the present invention.

### EXAMPLES

### Example 1

1 g Carboxymethyl chitosan (IR spectra data is shown in FIG. 3) is dissolved into 50 ml H₂O at room temperature, and 0.66 g acetaldehyde are added with stirring. After 1 h, 0.85 g NaBH₄ solution (10%) is added and the reaction is carried out for 2 h. The solution is precipitated in acetone and the precipitants are filtrated. The unreacted aldehyde and other inorganic products are extracted in a Soxhlet apparatus with EtOH for 24 h. And then the N-substituted chitosan derivatives are obtained after lyophilization. 0.4 g N-substituted chitosan is dispersed into 20 ml N-methyl-2-pyrrolidone (NMP) for 12 h at room temperature. To this mixture, 48 μl NaOH (1 M), 0.6 g NaI and 1.5 g CH₃I are added, and each reaction is carried out with stirring at 50° C. for 12 h. The solution is precipitated by excess acetone and the precipitations are filtered. The quaternized carboxymethyl chitosan iodide is obtained by lyophilization. Quaternized carboxymethyl chitosan chloridize and quaternized carboxymethyl chitosan bromize are obtained after quaternized carboxymethyl chitosan iodide is anion-exchanged. The molecular weight of chitosan is 1600 with the degree of deacetylation 80% in this example. And the derivative is confirmed by IR spectra (the structure is shown in FIG. 4: R=ethyl, X=I, n=3).

In step a) the ratio of reacted carboxymethyl chitosan and used aldehyde is 1:3; In step c) the degree of quaternization is 30.2%, and the pH of the reaction solution is 9.

### Example 2

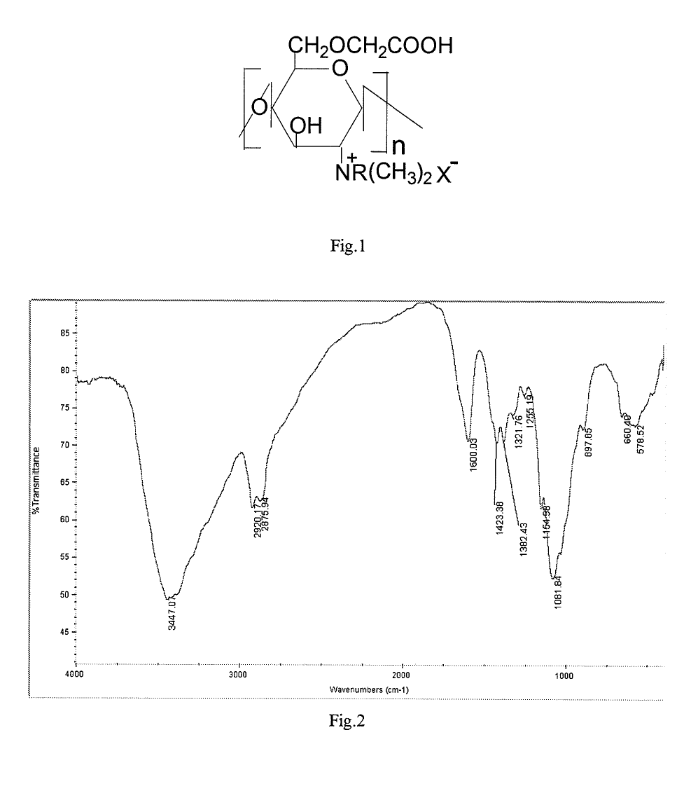

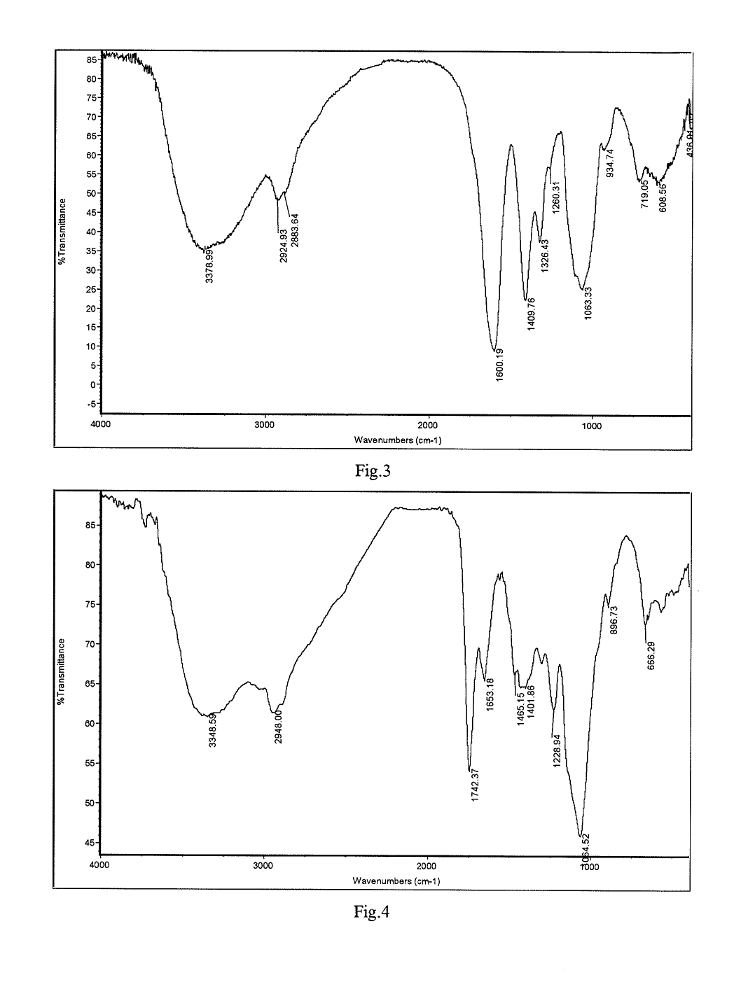

1 g Carboxymethyl chitosan (IR spectra data is shown in FIG. 2) is dissolved into 50 ml water at room temperature, and 1.2 g butyraldehyde are added with stirring. After 1.5 h, 1 g NaBH₄ solution (10%) is added and the reaction is carried out for 2 h. The solution is precipitated in acetone and the precipitants are filtrated. The unreacted aldehyde and other inorganic products are extracted in a Soxhlet apparatus with EtOH for 24 h. And then the N-substituted chitosan derivatives are obtained after lyophilization. 0.4 g N-substituted chitosan is dispersed into 20 ml N-methyl-2-pyrrolidone (NMP) with stirring for 12 h at room temperature. To this mixture, 48 μl NaOH (1 M), 0.6 g NaI and 1.5 g CH₃I are added, and each reaction is carried out with magnetic stirring at 50° C. for 12 h. The solution is precipitated by excess acetone and the precipitations are filtered. The quaternized carboxymethyl chitosan iodide is obtained by lyophilization. Quaternized carboxymethyl chitosan chloridize and quaternized carboxymethyl chitosan bromize are obtained after quaternized carboxymethyl chitosan iodide is anion-exchanged. The molecular weight of chitosan is 20000 with the degree of deacetylation 85% in this example. And the derivative is confirmed by IR spectra (the structure is shown in FIG. 4: R=n-butyl, X=Br, n=26).

In step a) the ratio of reacted carboxymethyl chitosan and aldehyde is 1:4; In step c) the degree of quaternization is 20.9%, and the pH of the reaction solution is 9.

### Example 3

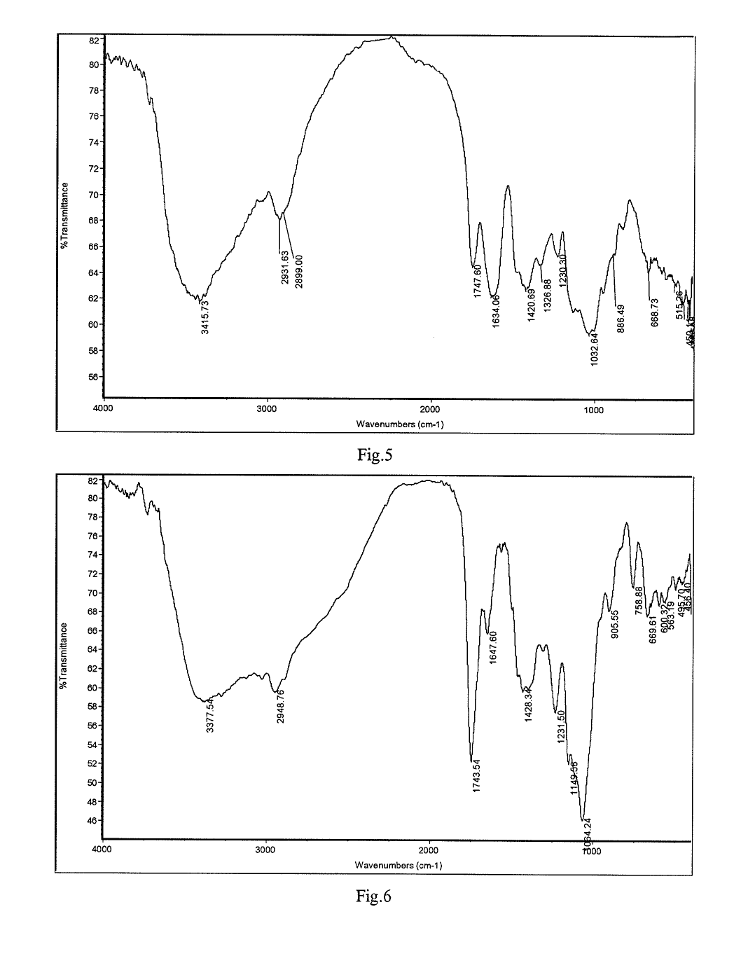

1 g Carboxymethyl chitosan (IR spectra data is shown in FIG. 2) is dissolved into 50 ml water at room temperature, and 2 g benzaldehyde are added with stirring. After 1.5 h, 1.3 g NaBH₄ solution (10%) is added and the reaction is carried out for 2 h. The solution is precipitated in acetone and the precipitants are filtrated. The unreacted aldehyde and other inorganic products are extracted in a Soxhlet apparatus with EtOH for 24 h. And then the N-substituted chitosan derivatives are obtained after lyophilization. 0.4 g N-substituted chitosan is dispersed into 20 ml N-methyl-2-pyrrolidone (NMP) for 12 h with stirring at room temperature. To this mixture, 48 μl NaOH (1 M), 0.6 g NaI and 1.5 g CH₃I are added, and each reaction is carried out with stirring at 50° C. for 12 h. The solution is precipitated by excess acetone and the precipitations are filtered. The quaternized carboxymethyl chitosan iodide is obtained by lyophilization. Quaternized carboxymethyl chitosan chloridize and quaternized carboxymethyl chitosan bromize are obtained after quaternized carboxymethyl chitosan iodide is anion-exchanged. The molecular weight of chitosan is 200000 with the degree of deacetylation 98% in this invention. And the derivative is confirmed by IR spectra (the structure is shown in FIG. 6: R=benzal, X=Cl, n=1360).

In step a) the ratio of reacted carboxymethyl chitosan and added aldehyde is 1:4; In step c) the degree of quaternization is 41.5%, and the pH of the reacted solution is 9.

### Example 4

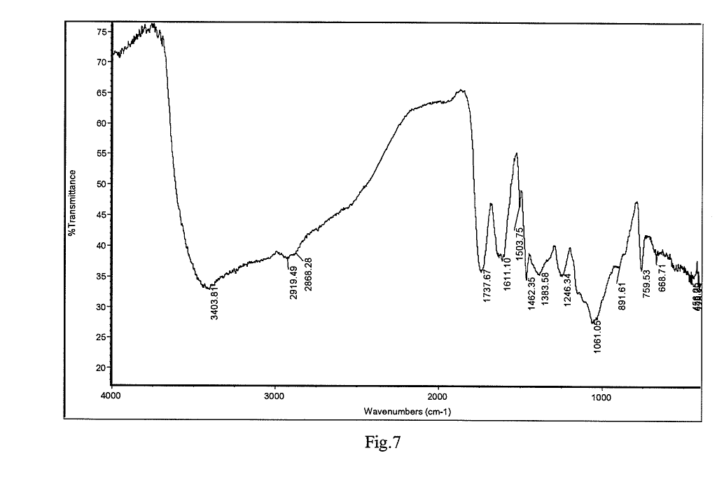

1 g Carboxymethyl chitosan (IR spectra data is shown in FIG. 2) is dissolved into 50 ml water at room temperature, and 3.1 g salicylaldehyde are added with stirring. After 3 h, 2.8 g NaBH₄ solution (10%) is added and the reaction is carried out for 4 h. The solution is precipitated in acetone and the precipitants are filtrated. The unreacted aldehyde and other inorganic products are extracted in a Soxhlet apparatus with EtOH for 72 hour. And then the N-substituted chitosan derivatives are obtained after lyophilization. 0.4 g N-substituted chitosan is dispersed into 20 ml N-methyl-2-pyrrolidone (NMP) for 12 h with stirring at room temperature. To this mixture, 48 μl NaOH (1 M), 0.6 g NaI and 1.5 g CH₃I are added, and each reaction is carried out with stirring at 50° C. for 12 h. The solution is precipitated by excess acetone and the precipitations are filtered. The quaternized carboxymethyl chitosan iodide is obtained by lyophilization. Quaternized carboxymethyl chitosan chloridize and quaternized carboxymethyl chitosan bromize are obtained after quaternized carboxymethyl chitosan iodide is anion-exchanged. The molecular weight of chitosan is 800000 with the degree of deacetylation 95% in this invention and the derivative is confirmed by IR spectra (the structure is shown in FIG. 7; R=2-hydroxy-phenyl, X=I, n=2000).

In step a) the ratio of reacted carboxymethyl chitosan and aldehyde is 1:5; In step c) the degree of quaternization is 40.2%, and the pH of the reacted solution is 9.

What is claimed:

1. Quaternized carboxymethyl chitosan derivatives, characteristic structure is: 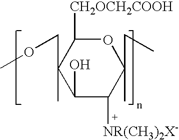
wherein R is aliphatic and aromatic groups; X is I, Br or Cl; n=3-2000 (degree of polymerization).

2. A method for the preparation of quaternized carboxymethyl chitosan derivatives according to claim 1, characterized in that:
a) Schiff bases of carboxymethyl chitosan are obtained from the reaction of active amido and aldehydes;
b) the N-substituted carboxymethyl chitosan of step a) are obtained from the reaction of Schiff bases of carboxymethyl chitosan and NaBH₄;
c) quaternized carboxymethyl chitosan iodide are obtained from the reaction of the N-substituted carboxymethyl chitosan of step b) and CH₃I under alkali condition;
d) quaternized carboxymethyl chitosan chloridize and quaternized carboxymethyl chitosan bromize are obtained after the quaternized carboxymethyl chitosan iodide of step c) is anion-exchanged; the degree of quaternization of this compound is 20.3-41.5%.

3. The method according to the claim 2, characterized in that: in step a) ratio of the carboxyethyl chitosan and the aldehyde is 1:3-1:5, and the reaction time is 1-3 h.

4. The method according to the claim 2, characterized in that: in step b) the Schiff bases of carboxymethyl chitosan is deoxidized by NaBH₄, and ratio of NaBH₄ and aldehyde used is 1.5:-1:3; and the reaction time is 2-4 h.

5. The method according to the claim 2, characterized in that: in step a) the molecular weight of used chitosan is 0.16×10⁴-80×10⁴ with the degree of deacetylation 80-100%.

6. The method according to the claim 2, characterized in that: in step c) the N-substituted carboxymethyl chitosan is dispersed into N-methyl-2-pyrrolidone for 12 h with stirring at room temperature, and then the pH of this mixture is adjusted to 9 by 1 mol/L NaOH; N-substituted carboxymethyl chitosan reacts with CH₃I (5 fold excess to added Carboxymethyl chitosan), and the concentration of I⁻ of this solution is adjust to 0.2 mol/L with CH₃I; the reaction time is 12 h.
